(19) United States
(12) Patent Application Publication
(10) Pub. No.: US 2015/0027125 A1
(43) Pub. Date: Jan. 29, 2015

(54) PROCESS FOR HARVESTING, STORING, AND USING RENEWABLE ENERGY TO PROPEL AND POWER BOATS AND SHIPS, AND MAXIMIZE THEIR AVERAGE SPEED

(71) Applicant: ANIL RAJ, HARVEY, LA (US)

(72) Inventor: ANIL RAJ, HARVEY, LA (US)

(21) Appl. No.: 14/339,649

(22) Filed: Jul. 24, 2014

Related U.S. Application Data
(60) Provisional application No. 61/857,762, filed on Jul. 24, 2013.

(51) Int. Cl. B63H 1/04; F03D 9/00; B63H 19/00; B63G 8/00; B63B 39/00; B63H 21/17; B63H 21/21; B63B 35/00; B63H 9/02; B63H 19/02

(52) U.S. Cl. CPC B63H 1/04; B63H 9/02; F03D 9/00; B63H 19/00; B63H 19/02; B63B 39/00; B63H 21/17; B63H 21/21; B63B 35/00; B63G 8/001; B63H 2021/003
USPC 60/720

(57) ABSTRACT

A boat or ship (marine vessel) can be powered and propelled by using wind or solar energy. This propulsion results in the forward movement and six degrees of motion (roll, heave, pitch, yaw, surge, and sway) of the marine vessel. These motions have kinetic energy. This invention capitalizes on the fact that the solar wind and wave energy are cyclical by nature. The present invention enables the vessel to store energy harvested from these energy sources during periods when levels of energy is available from wind, solar, or the motion of the vessel in waves. This invention makes this stored energy available for use during periods when the external natural sources of energy (wind, wave, or solar) are not available in adequate quantities to maintain a reasonable speed of advance for the marine vessel. The harvesting of the energy during high energy cycles, storing it and using it when needed in this invention allows a marine vessel to get maximum speed of advance over a course. In this invention the marine vessel can maintain faster average speed without reliance on any fossil or chemical fuel and by only using renewable energy sources. In this invention the vessel is normally driven by wind channeling methods like canvas or foil sails or Flettner rotors. In addition to this, the vessel can be propelled by propulsion thrusters such as propellers, rim driven thrusters, azimuthing drives, water jets or other means of thrusting and propelling the vessel. These propulsion devices are driven by regenerative electric motors using stored electric energy in batteries on the vessel. The energy stored in the battery bank is used to provide supplemental or primary propulsion during cyclical periods when natural sources of wind, wave or solar energy are low. These same thrusters and their electric motors work in reverse to generate and harvest energy when wind levels are high and as the marine vessel is moving forward at higher speeds while being propelled by wind energy. In this invention the batteries, which are dense and heavy, to store this energy, are secured in the bottom of the marine vessel also serve as ballast to keep the vessel upright. This serves to lower the marine vessel's center of gravity to get the maximum hull stability for safety. This also helps the vessel channel maximum available wind energy to propel the vessel and harvest energy whenever stronger winds permit.

### CROSS-REFERENCE TO RELATED APPLICATIONS

Not Applicable

### STATEMENT REGARDING FEDERALLY SPONSORED RESEARCH OR DEVELOPMENT Not Applicable

### REFERENCE TO SEQUENCE LISTING, A TABLE, OR A COMPUTER PROGRAM LISTING COMPACT DISK APPENDIX

Not Applicable

### REFERENCES CITED

US patent 20110281478, Benjamin Blumenthal, “Systems, Devices and Methods for Providing Energy for Ship Propulsion”, issued Nov. 17, 2011

US patent 20110204641, Martin Corrudini, “Hydroelectric Turbine Based Power-Generating System for Vessels and Submarines”, issued Aug. 25, 2011

US patent 20080272605, Robert M. Borden and Wendell M. Smith, “Wind Power System”, issued Jun. 11, 2008

U.S. Pat. No. 6,329,725, Robert M. Woodall and Philip J. Grossweiler, “Systems and Methods for Utilizing Excess Electric Power from a Marine Transportation Vessel”, issued Dec. 11, 2001

U.S. Pat. No. 6,107,691, Gerald E. Gore, Wayne K. Wittman, Harry T. Roman, Robert A. Gore, Michael D. Gore, Methods for Utilizing the Electrical and Non Electrical Outputs of Fuel Cell Powered Vehicles”, issued Aug. 22, 2000

U.S. Pat. No. 4,102,291, Ralph Sebald, “Electrical Generator for a Sailboat”, issued Aug. 25, 1978

US patent 20070077830, Wolfgang Rzadki, Matthias Schulze, Ronald Volzke, Bernd Wacker, “Power Generation, Distribution and On-Board Power Supply System for Low-Emissive Surface Marine (Navy) Ships of Different Classes and Sizes”, issued Apr. 5, 2007

US patent 20100221962, Jiin Juh Su, “Fuel Efficient Power System for Electric Boat”, issued Sep. 2, 2010

U.S. Pat. No. 4,369,630, Warren Bloomfield, “Combination Drive System for Ships”, issued Jan. 5, 1983

U.S. Pat. No. 8,230,798, Rolf Rohden, “Magnus Rotor”, issued Jul. 31, 2012

### BACKGROUND OF THE INVENTION

1. Field of Invention

Embodiments of the present invention relate to marine vessels and their ability to attain maximum speed over a course by only using, harvesting, storing and expending energy from the sun, the wind, and the motion of the vessel in waves.

2. Relevant Background

Marine vessels have sailed using the wind as the primary source of energy longer than written history has been recorded. However, harvesting and storing of wind energy from the forward motion of the vessel, and kinetic energy from six degree of freedom motions of the vessel for the purpose of increasing the vessels speed over a course is a new concept. Similarly, solar panels have been used to generate and store energy for a variety of land based and marine applications but the inclusion of these in this process is also a new concept. The vessel when moving forward in waves picks up six degree of freedom motions. These are called Pitch, Roll, Yaw, Surge, Sway and Heave. These movements or excitations of the vessel from the waves impart energy into the marine vessel's hull to create this motion. Devices have been recently developed to recover some of this energy from such movements to generate power, however, the channeling of this energy for the purpose of harvesting, storing and using it to increase the speed of the vessel has not been seen before. Marine vessels, whose forward movement is propelled with the wind, use heavy dense material as ballast in the bottom of the vessel to maintain the stability of the vessel as the power of the sails threatens to overturn the vessel. Historically, lead cannon shots and other dense weight materials such as concrete with iron in it have been used to keep such vessels upright. This is called “ballast.” Ballast of this nature makes the marine vessel heavier and reduces its cargo carrying capacity and speed. The new idea of using heavy electrical energy storage devices, such as batteries, in lieu of ballast, allows for more stability and allows the vessel to use maximum wind energy as it stays upright. This same ballast functioning to store energy to increase the speed of the vessel over a long distance is a new concept.

### SUMMARY OF THE INVENTION

The present invention is a system for harvesting nature's wind and solar power into electrical energy on a marine vessel for storage onboard. This invention capitalizes on the fact that availability of large amounts of solar, wind, and wave energy are cyclical in nature. This harvested and stored energy is used during cycles when natural energy sources are not adequately available to maximize the average speed of the vessel over a voyage. The invention depends on the technical fact that the speed versus power curve of a marine vessel is much steeper at the higher speed range and flatter at the lower speed range (see FIG. 8). It can be seen in this curve that when the vessel's speed is high, due to higher winds, if the vessel goes into “harvesting” mode, the loss of speed 14 is relatively low, while the rate of harvesting is high 9. This allows harvesting of relatively large amounts of energy 9 with a minimal compromise in speed 14. It can also be seen in this curve that when the vessel is moving slowly when winds and other external sources of energy like solar are low, the vessel's speed can be increased significantly 13 by using relatively little energy 10. Therefore, harvesting energy, when the wind and vessel speeds are high, collects large amounts of energy while losing only small amounts of speed. Similarly, when the vessel speed is low because of low wind speed or no sun, the stored energy is used to provide significant increases in propulsive speed to the vessel over a range. Because the speed versus power curve is flat at lower vessel speeds, relatively lesser stored energy is consumed with corresponding higher speed increases. This results in increased average speed gain over the length of the vessel's voyage. The vessel may be propelled using wind energy from canvas or foil sails or singular or multiple Flettner rotors being called wind harnessing devices. Propulsion power created by the wind harnessing devices captures and uses the energy to propel the marine vessel and harvests a part of this energy as electric energy or in the form of the fuel cells using one or more regenerative propeller and motor system as hydraulic turbines. Additional electrical energy is also harvested from solar panels and from the wave generated motions of the marine vessel's hull. Electric energy produced by these means is directed to an energy storage and management system. This deposits excess power harvested to the vessel's energy storage system to be used later upon demand. When wind speeds are low resulting in lower vessel speeds, the stored power is used to increase the vessel speed by using the electric propulsion motors, also known as propelling the vessel in “motor sailing” mode. Similarly, additional electric power is continually harvested and stored from solar panels when the sun's radiation is high. When the vessel is in “motor sailing” mode it will use the stored energy to create supplemental propulsion power by using the regenerative motors on the propeller(s) to increase the vessel speed in order to maximize the average speed over the length of the voyage.

The objective of the present invention is to provide a reliable system for providing propulsion and on board a marine vessel by the use of naturally harvested energy. Such energy is harvested and stored during high external energy cycles (wind, sun, or waves) and expended during low external energy cycles. Such a vessel may be a commercial marine transport vessel, a pleasure yacht, a research vessel, or autonomous surface or submarine vessel used by Naval Forces. Such a vessel can be propelled without the use of any fossil, chemical or radioactive fuel, while maintaining maximum possible speed over a long voyage. Energy is harvested using the wind as means of propelling the vessel and harvesting some of the energy. This is done with the aid of sails or Flettner rotors, solar panels, regenerative propeller(s), optimized hull form, motion energy absorption devices and a comprehensive energy management system. Another objective of this invention is to provide such a system which is practical to apply and economic to maintain and repair. A further objective is to have a zero emission marine vessel with unlimited endurance and good speed of advance. For naval autonomous vessels, such an invention extends the endurance. Naval autonomous submarines can surface at night to recharge their fuel while cruising, and then submerge during the day to avoid detection.

### BRIEF DESCRIPTION OF THE DRAWING

FIG. 1 is a perspective view of a type of marine vessel (catamaran with Flettner rotors and solar panels) using the present invention;

FIG. 2 is a perspective view of a common sailboat which can also use the present invention;

FIG. 3 is a front view of a catamaran marine vessel which can use the present invention;

FIG. 4 is an image of a naval autonomous underwater vehicle (AUV) which can use retractable Flettner rotors 2 and regenerative propellers 5 to gain extended autonomy;

FIG. 5 is a top view of a marine vessel hull of the present invention with retractable regenerative propellers, which can be used to harvest energy underway, and propel the vessel during low energy cycles;

FIG. 6 is an Energy Flow Diagram of the Harvest and Maximum Usage Cycles;

FIG. 7 is an Energy Flow Diagram of the Harvest and Maximum Usage Cycles; and

FIG. 8 is a typical Speed/Power curve of the marine vessel which forms the basis of the present invention;

### REFERENCE NUMERALS IN THE DRAWINGS

1 Disc attached on the top of each rotor
2 Flettner rotors
3 Solar panels
4 Hull
5 Regenerative propellers
6 Battery bank
7 Electric motor/generator
8 Water flow causing power generation to charge batteries
9 Energy harvest storage rate
10 Stored energy depletion rate supplementing speed
11 Canvas or foil sail
12 Flettner electric motor
13 Speed gain from use of stored energy
14 Speed loss in energy harvest mode
15 Magnetic levitation of rotors to reduce friction

### DETAILED DESCRIPTION OF THE INVENTION

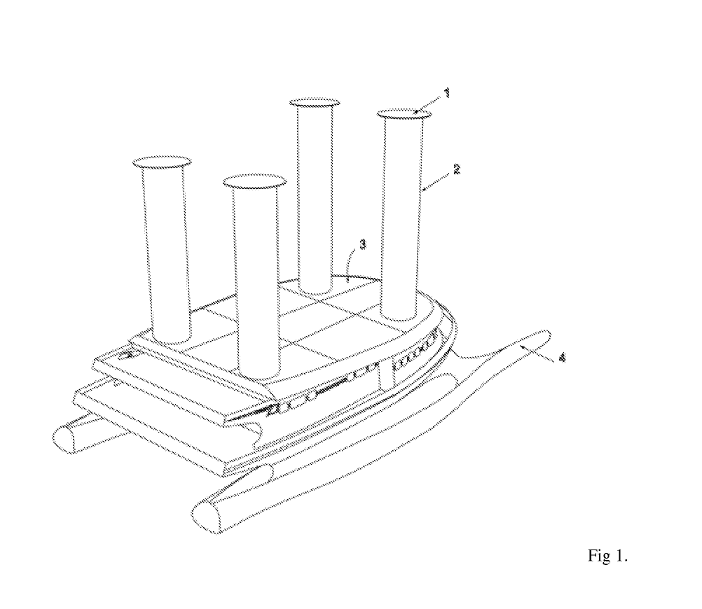

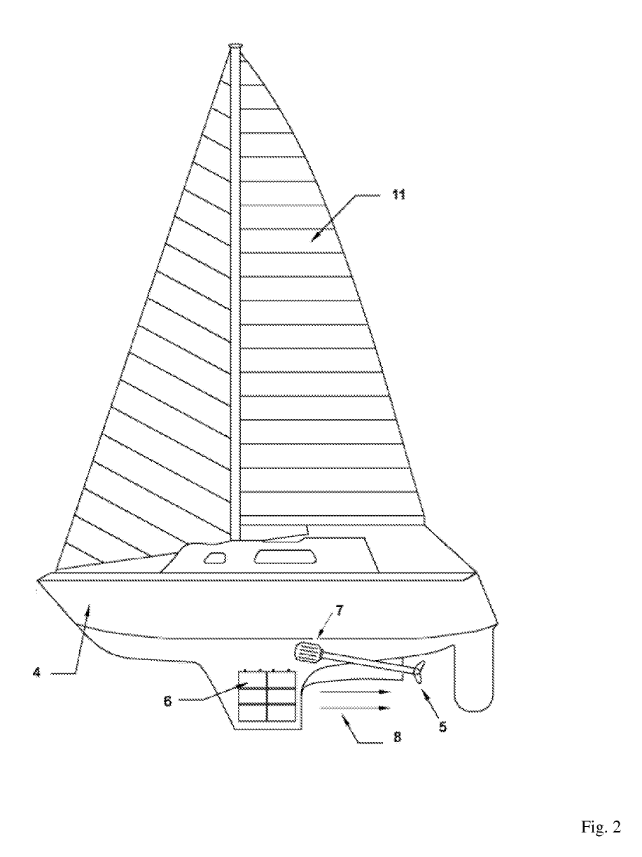

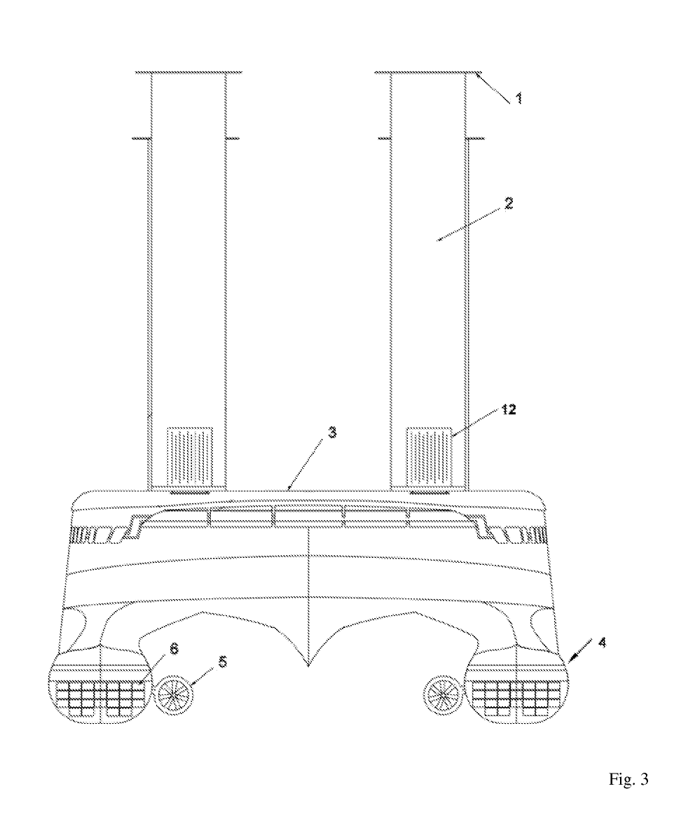

FIG. 1 and FIG. 3, show a catamaran type of marine vessel with four vertical Flettner rotors 2, to which a disc 1 is attached on the top of each rotor. These Flettner rotors 2 are used as means of a driving force using the Magnus principle to push the marine vessel's hull 4 forward in the water in a desired direction, much like the manner in which a sail acts as a driving force on a sailboat FIG. 2. Regenerative propellers 5 are located on the side of each hull of the catamaran or under a mono hull to harvest energy from the flowing water 8 when the marine vessel's hull 4 is in forward motion due to the driving force from the wind on the Flettner rotors 2. Solar panels augment the energy produced for vessel's use. The combined excess energy is stored by an energy management system (EMS) into a battery bank 6, or in the form of fuel cells located at the bottom of the marine vessel near the keel. The dense batteries 6 in the keel also serve to lower the center of gravity of the marine vessel, increasing the marine vessel's stability and safety, and also allowing for maximum energy harvesting from wind and thus the flowing water. Each regenerative propeller 5 can also provide propulsion to the vessel during the cycles when winds are low and energy harvesting is impractical FIG. 8.

In more detail, still referring to the invention of FIG. 1 and FIG. 3, Flettner rotors 2 will create a driving force through the Magnus Effect, a phenomenon occurring when a spherical or cylindrical object rotates in a flowing fluid stream 8, resulting in a lifting force on the object perpendicular to the fluid-flow. Hence, the Flettner rotors 2 create the same effect as a canvas sail or foil sail 11 would on a vessel FIG. 2, but with a larger range of control.

The regenerative propellers 5 can be Rim Driven Thrusters which do not have hubs or axial shafts at the center which help reduce additional drag either in driving or in driven mode. The regenerative propellers 5 work like turbines when placed in a stream of water. The forward motion of the marine vessel's hull 4 with respect to the water creates the said stream of water, thus driving a rim type alternator device within the regenerative propeller 5 which produces electricity. A standard propeller properly designed for such function on a common sailboat FIG. 2, would have the same effect.

Solar panels 3 are positioned on the upper deck and cover most of the vessel's surface area exposed to sunlight, producing additional energy for harvesting which is stored in the battery bank 6. Solar panels 3 are durable and heavy duty to resist harsh weather and also to provide insulation.

In more detail, referring to the invention in FIG. 6, during suitable wind speeds and when energy harvesting is ideal FIG. 8, electric energy stored in the batteries 6 flows to the energy management system (EMS); from which it is directed to the motors 12 in the Flettner rotors 2 ensuing in their controllable rotational speeds, and, through the Magnus Effect, resulting in the forward motion of the marine vessel's hull 4.

The forward motion of the marine vessel's hull 4 allows the water to flow 8 through the regenerative propellers 5 causing them to rotate and drive the alternator device within to produce electricity. The electricity produced by the regenerative propellers 5 and the solar panels 3 is collected by the energy management system (EMS) and is fed back to the battery bank 6.

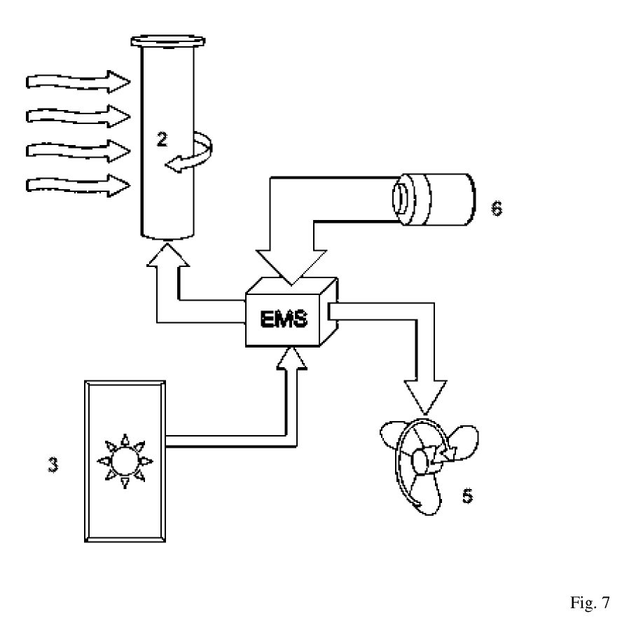

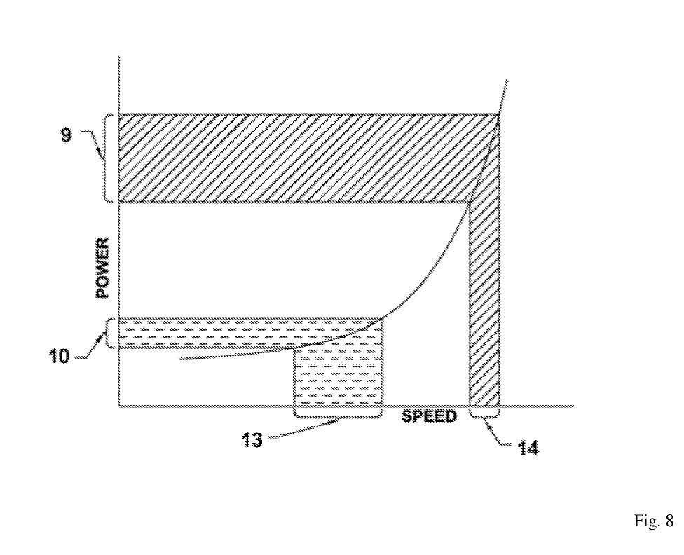

In more detail, referring to the invention in FIG. 7, during unsuitable wind speeds and when energy harvesting is impractical FIG. 8, electric energy stored in the batteries 6 flows to the energy management system (EMS); from which it is directed to the motors 12 in the Flettner rotors 2 and to the regenerative propellers 5. The driving thrust produced by the propellers, when added to any thrust being provided by the rotors 2 due to the wind, will combine to give higher speeds to the marine vessel's hull 4.

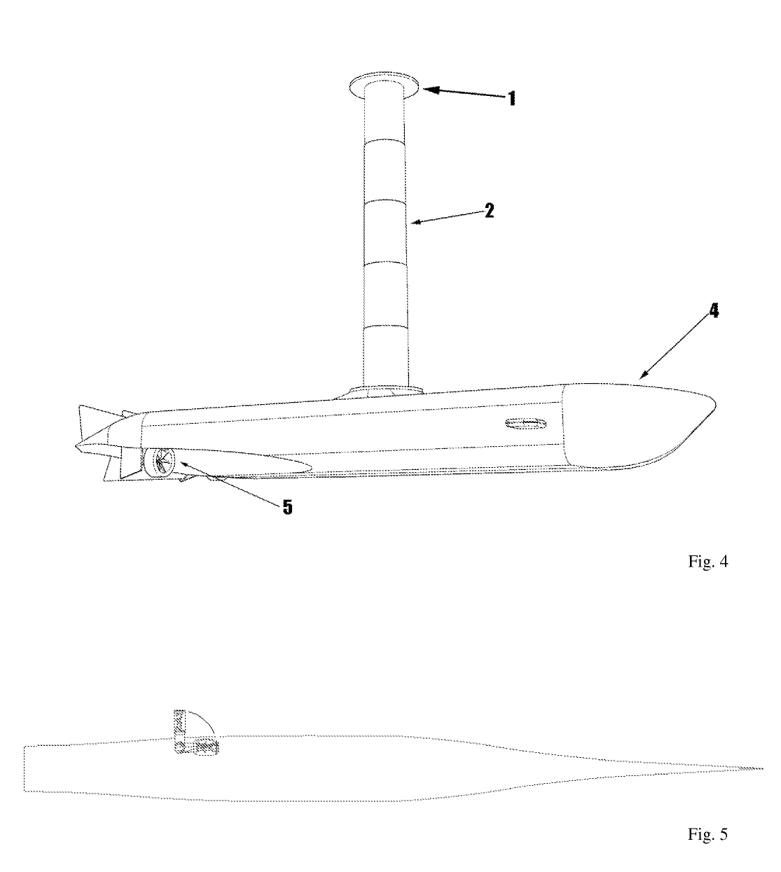

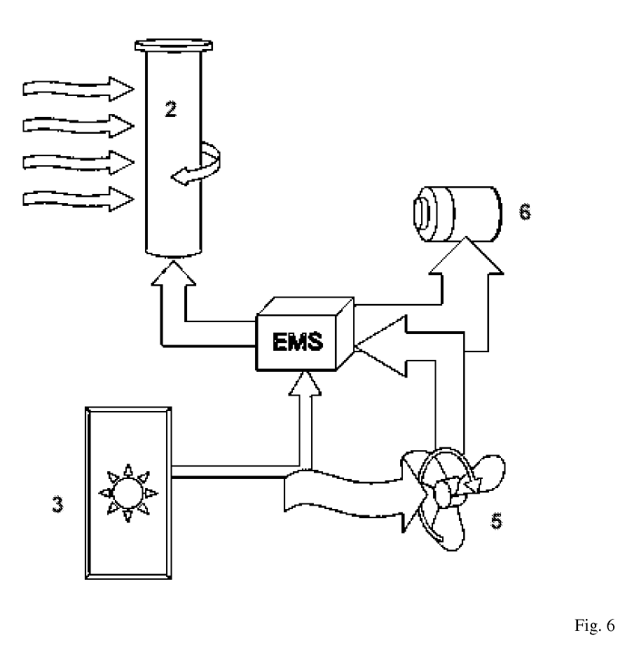

Excess electric energy produced is directed to an energy management system (EMS) which then stores it in a battery bank 6 located at the lowest space of the hull FIG. 4. This configuration will provide a low center of gravity and improved vessel stability. Batteries 6 are modular, lightweight and are stored in a cellular grid where they can be easily accessed for maintenance and replacement. The charge and discharge cycles are monitored by the EMS to increase battery life time.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention.

I claim:

1. A system comprising of many technologies and processes integrated into a single process to create a zero emission, zero fossil or chemical fueled marine vessel which has a long range and increased speed over the range.

2. A system which uses the marine vessel's propulsion system to harvest wind energy through the water by forward motion of the vessel, store it and use it to increase average vessel speed when winds are not as favorable.

3. A system which uses the marine vessel's six degrees of freedom motion in the water (pitch, roll, yaw, heave, surge and sway) to harvest energy.

4. A marine system which stores the harvested energy and uses this stored energy during periods when winds are light to increase the speed of the marine vessel over a range.

5. A system which uses propulsion system driven by electric motors in regenerative mode to harvest and collect the energy.

6. A system which uses Rim Driven Thrusters or propellers to harvest energy as well as propel the marine vessel.

7. A system which uses the storage batteries or fuel cells as ballast low in the hull to increase the vertical stability of the marine vessel, and maximize the vessel's ability to exploit wind energy for propulsion and harvesting.

8. A system which uses energy storage batteries mounted in a rack storage system, wherein the racks have integral conductors to connect multiple batteries, and batteries can be changed out by sliding them in and out of the rack.

9. A system which combines a low resistance hull form like a fine mono hull, Catamaran, Tri-maran, super slender, or planning hull form with a wind energy harvesting, storage and regenerative propulsion system to create a higher speed, long range marine vessel which can make faster speeds without the use of fossil or chemical fuels.

10. A system which combines harvested wind and solar energy for storage on board a marine vessel for re-use when wind and sun cycles have low energy yield.

11. An energy management and control system which optimizes the energy harvesting process on a marine vessel.

12. A management and control system which optimizes the Flettner rotor rotational speed on a marine vessel to exploit maximum wind energy usage and harvesting. by changing the rotor speed automatically to optimize wind usage

13. A management and control system which can use multiple Flettner rotors to change the direction of a marine vessel, by rotating different rotors at different rotational speeds and in different directions.

14. A method of applying energy harvested by autonomous naval surface or underwater vehicles to extend its autonomy using the principles in this invention.

15. A system which uses magnetic levitation of Flettner rotors in such a system to reduce friction and increase efficiency.
